(19) United States
(12) Patent Application Publication
(10) Pub. No.: US 2001/0044663 A1
(43) Pub. Date: Nov. 22, 2001

(54) SOUND CONTROLLER

(76) Inventor: SANG WEON LEE, SEOUL (KR)

Correspondence Address: MORGAN LEWIS & BOCKIUS, 1800 M STREET NW, WASHINGTON, DC, 200365869

(21) Appl. No.: 08/953,626

(22) Filed: Oct. 17, 1997

(30) Foreign Application Priority Data
Dec. 26, 1996 (KR) 72328/1996

(51) Int. Cl. G06F 17/00

(52) U.S. Cl. 700/94

(57) ABSTRACT

A sound controller serves as a voice source control apparatus capable of applying an effect to digital audio wave file data or to voice data by controlling an effector and a coder/decoder (CODEC). The controller includes a controller for interpreting digital audio wave file data received from a PC expansion bus slot and CODEC, and carries out a control operation after judging whether an effect is to be applied thereto, a wave table music synthesizer for interpreting MIDI file data received from the PC expansion bus slot, an effector for applying an effect to output data values from the wave table music synthesizer and the controller and outputting the effected result to the controller, and a CODEC for converting an effected output value from the controller into an analog audio signal and outputting the resultant analog audio signal to a speaker.

### BACKGROUND OF THE INVENTION

1. Field of the Invention

The present invention relates to a sound controller, and more particularly to an improved sound controller for generating a variety and an abundance of sounds by applying an effect on wave files, voice data and the like.

2. Description of the Prior Art

As shown in FIG. 1, a conventional sound controller includes: a controller 10 and a wave table music synthesizer 20 for respective interpreting digital audio wave file data and MIDI (Musical Instrument Digital Interface) file data which are respectively outputted from a personal computer (PC) expansion bus slot; an effector 30 for applying effects to an output of wave table music synthesizer 20; and a coder/decoder (CODEC) 40 for converting digital data values outputted from controller 10 and effector 30 into an analog audio signal, and outputting the resultant analog audio signal to a speaker 50.

The operation of the thusly constituted sound controller will now be described with reference to the accompanying drawings.

First, for generating sounds there are two kinds of data inputs such as a digital audio wave file data and a MIDI file data which are provided from a corresponding PC expansion bus slot.

The digital audio wave file data provided from a PC expansion bus slot is interpreted in controller 10 and outputted to CODEC 40, and the MIDI file data is interpreted in wave table music synthesizer 20 and outputted to CODEC 40 for being effected by effector 30.

As a result, CODEC 40 converts output digital data values of controller 10 and effector 30 into an analog audio signal, and outputs the resultant analog audio to speaker 50.

However, in the conventional sound controller, an effect can only be applied to MIDI file data and is not appropriate to voice data being received through a digital audio wave file data or a CODEC, whereby users have been prevented from listening to real effected sound.

### SUMMARY OF THE INVENTION

Therefore, it is an object of the present invention to provide a sound controller for applying an effect to digital audio wave file data received from a PC expansion slot and to voice data received from a CODEC, thereby generating a variety and an abundance of sounds.

To achieve the above-described object, there is provided a sound controller according to the present invention which includes a controller for interpreting digital audio wave file data received from a PC expansion bus slot and a CODEC, and carrying out a control operation after judging whether an effect is to be applied thereto, a wave table music synthesizer for interpreting MIDI file data received from the PC expansion bus slot, an effector for applying an effect to output digital audio values from the wave table music synthesizer and the controller and outputting the effected result to the controller, and a CODEC for converting an effected output value of the controller into an analog audio signal and outputting the resultant analog audio to a speaker.

### BRIEF DESCRIPTION OF THE DRAWINGS

FIG. 1 is a schematic block diagram of a conventional sound controller;

FIG. 2 is a schematic block diagram of a sound controller according to the present invention; and

FIG. 3 is a detailed schematic block diagram of a controller in the sound controller of FIG. 2.

### DETAILED DESCRIPTION OF THE INVENTION

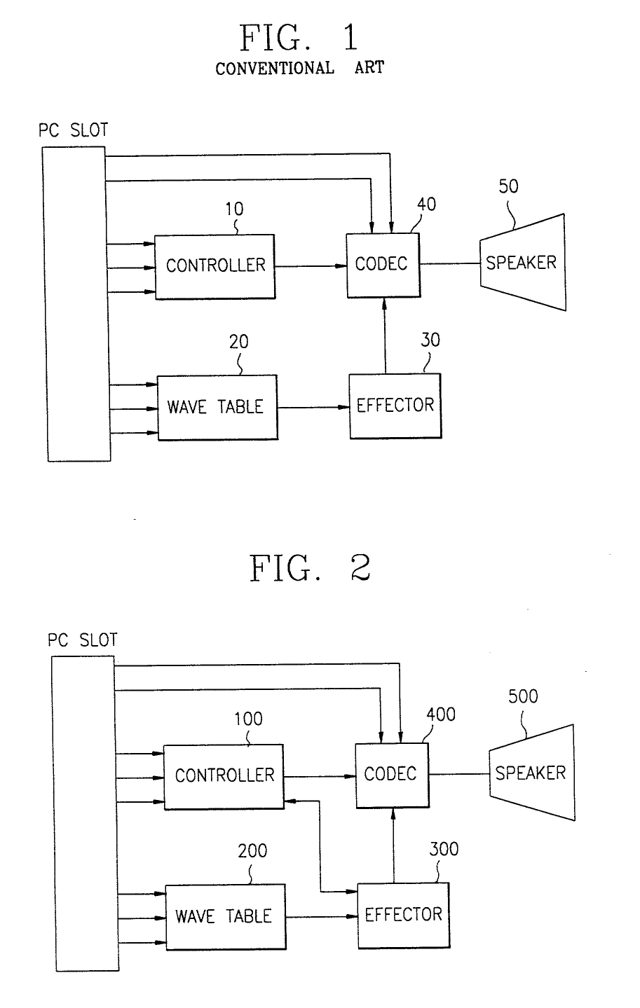

As shown in FIG. 2, a sound controller according to the present invention includes: a controller 100 for interpreting digital audio wave file data received from a PC expansion bus slot and a CODEC, and carrying out a control operation after judging whether an effect is to be applied thereto; a wave table music synthesizer 200 for interpreting MIDI file data received from the PC expansion bus slot; an effector 300 for applying effects to output data values from wave table music synthesizer 200 and controller 100 and outputting the resultant effected data to controller 100; and a CODEC 400 for converting an effected output value from the controller 100 into an analog audio signal and outputting the resultant analog audio to a speaker 500.

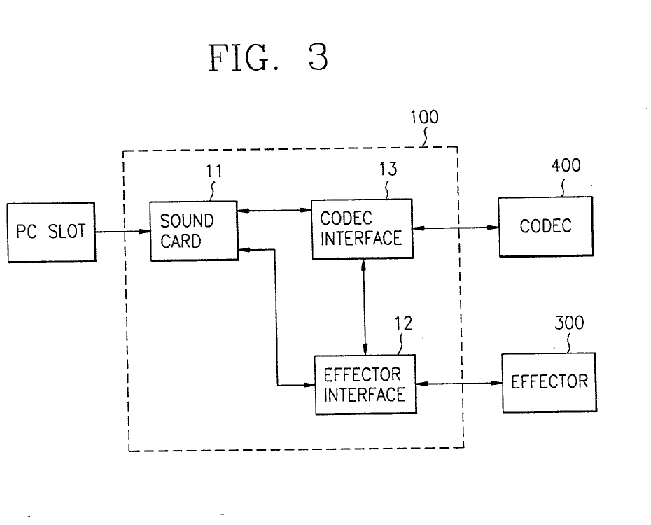

Controller 100, as shown in FIG. 3, includes: a sound card 11 for interpreting digital audio wave file data received from a PC expansion bus slot and judging whether an effect is to be applied thereto; an effector interface 12 for interfacing sound card 11 with the external effector 300; and a CODEC interface 13 for interfacing sound card 11 and effector interface 12 with the external CODEC 400.

The operation of the thusly constituted sound controller according to the present invention will now be described.

When digital audio wave file data received from a PC expansion bus slot is applied to controller 100, sound card 11 interprets the applied digital audio wave file data and judges whether an effect should be applied thereto.

At this time, when an effect is not to be applied to the digital audio wave file data, sound card 11 outputs the interpreted data through CODEC interface 13 to the external CODEC 400, whereby sound is generated via speaker 500.

However, when an effect is to be applied to the digital audio wave file data, sound card 11 outputs the interpreted data through effector interface 12 to the external effector 300, thus to be effected. Then, the effected data is controlled to be outputted to the external CODEC 400 through effector interface 12 and CODEC interface 13, thereby generating sounds via speaker 500.

That is, the present invention generates a variety and an abundance of sounds by applying effects even to digital audio wave file data.

Digital audio voice data received through CODEC 400 is inputted into sound card 11 through CODEC interface 13 and interpreted therein. Here, sound card 11 outputs the interpreted data through effector interface 12 to effector 300 to be effected, and the effected data is controlled to be outputted through effector interface 12 and CODEC interface 13 to the external CODEC 400.

Therefore, CODEC 400 converts an output of CODEC interface 13 into an analog audio signal and outputs the resultant analog audio to speaker 500 for sound generation.

Also, the MIDI file data received from the PC expansion bus slot is interpreted in wave table music synthesizer 200, effected in effector 300, and outputted through controller 100 and CODEC 400 to speaker 500.

As described above, the sound controller according to the present invention simultaneously controls a CODEC and an effector using a sound card and accordingly applies effects to digital audio wave file data received from a PC expansion bus slot and voice data received through a CODEC, thereby generating a variety and an abundance of sounds.

What is claimed is:

1. A sound controller, comprising:
a controller for interpreting digital audio wave file data received from a personal computer (PC) expansion bus slot and a coder/decoder (CODEC), and carrying out a control operation after judging whether an effect is to be applied thereto;
a wave table music synthesizer for interpreting musical instrument digital interface (MIDI) file data received from the PC expansion bus slot;
an effector for applying an effect to output digital data values of the wave table music synthesizer and the controller and outputting resultant effected digital audio data to the controller; and
the CODEC for converting the effected output value from the controller into an analog audio signal and outputting the resultant analog audio to a speaker.

2. The sound controller of claim 1, wherein the controller comprises:
a sound card for interpreting the digital audio wave file data received from the PC expansion bus slot and voice data received from the CODEC and judging whether an effect is to be applied thereto;
an effector interface for interfacing the sound card with the effector; and
a CODEC interface for interfacing the sound card and the effector interface with the CODEC.

3. The sound controller of claim 2, wherein the sound card simultaneously controls the CODEC and the effector.
